(19) United States
(12) Patent Application Publication
(10) Pub. No.: US 2026/0106098 A1
(43) Pub. Date: Apr. 16, 2026

(54) RELAY CONTROL SYSTEM

(71) Applicant: TOYOTA JIDOSHA KABUSHIKI KAISHA, Toyota-shi (JP)

(72) Inventor: Atsushi SHINOHARA, Chiryu-shi (JP)

(73) Assignee: TOYOTA JIDOSHA KABUSHIKI KAISHA, Toyota-shi (JP)

(21) Appl. No.: 19/256,690

(22) Filed: Jul. 1, 2025

(30) Foreign Application Priority Data
Oct. 11, 2024 (JP) 2024-179271

(51) Int. Cl. H01H 47/00; B60L 3/00; B60L 3/04

(52) U.S. Cl. CPC H01H 47/001; B60L 3/0046; B60L 3/04

(57) ABSTRACT

A relay control system comprising: a first control device that is operated by electric power from a battery and transmits a request for interruption of a relay; and a second control device that turns off the relay when a request for interruption from the first control device is received, wherein the second control device turns off the relay when the voltage of the battery is less than a predetermined voltage in a case where communication with the first control device is interrupted for a first time.

### CROSS-REFERENCE TO RELATED APPLICATION

This application claims priority to Japanese Patent Application No. 2024-179271 filed on Oct. 11, 2024. The disclosure of the above-identified application, including the specification, drawings, and claims, is incorporated by reference herein in its entirety.

### BACKGROUND

### 1. Technical Field

The present disclosure relates to a relay control system.

### 2. Description of Related Art

As a related relay control system, there has been proposed a system including a first control device (EV-ECU) that transmits a shutoff request for a relay (SMR), and a second control device (battery ECU) that turns off the relay when a shutoff request is received via communication with the first control device (see Japanese Unexamined Patent Application Publication No. 2024-64243 (JP 2024-64243 A), for example). In this system, when the communication with the first control device is interrupted, the second control device turns off the relay after a predetermined time has elapsed from the interruption. In this manner, the relay can be turned off when the communication between the first control device and the second control device is interrupted.

### SUMMARY

In the relay control system described above, the relay is shut off when the communication between the first control device and the second control device is interrupted. However, the interruption of the communication between the first control device and the second control device may occur when the voltage of a battery that supplies power to the first control device temporarily drops. Also, the interruption may be temporary and may be resolved after a while. Therefore, it is recognized as an important issue to turn off the relay at a more appropriate timing.

The relay control system according to an aspect of the present disclosure turns off the relay at a more appropriate timing.

The relay control system according to an aspect of the present disclosure adopts the following measures.

An aspect of the present disclosure provides a relay control system including a first control device that is operated by power from a battery and that transmits a shutoff request for a relay, and a second control device that turns off the relay when the shutoff request from the first control device is received via communication, in which when the communication with the first control device is interrupted for a first period of time, the second control device turns off the relay when a voltage of the battery is less than a predetermined voltage.

In the relay control system according to the aspect of the present disclosure, when the communication with the first control device is interrupted for a first period of time, the second control device turns off the relay when a voltage of the battery is less than a predetermined voltage. As a result, the relay can be turned off at a more appropriate timing.

In the relay control system according to an aspect of the present disclosure, when the communication with the first control device is interrupted for the first period of time and the voltage of the battery is less than the predetermined voltage, the second control device may turn off the relay when the communication with the first control device is continuously interrupted for a second period of time longer than the first period of time. In this way, the relay can be turned off at a more appropriate timing.

In the relay control system according to an aspect of the present disclosure, the relay control system may further include an informing device that indicates information; and when the communication with the first control device is interrupted for the first period of time and the voltage of the battery is less than the predetermined voltage, the second control device may control the informing device so as to indicate that the relay is turned off when the communication with the first control device is continuously interrupted for the second period of time. In this way, it is possible to inform a user of a vehicle that the relay is turned off, and thus it is possible to improve the convenience for the user.

In the relay control system according to another aspect of the present disclosure, when the communication with the first control device is interrupted for the first period of time, the second control device may transmit a transmission request for the shutoff request to the first control device via the communication when the voltage of the battery is less than the predetermined voltage, and may turn off the relay when the communication with the first control device is interrupted even after a third period of time elapses after the transmission request is transmitted. In this way, the relay can be turned off at a more appropriate timing.

In the relay control system according to still another aspect of the present disclosure, when the communication with the first control device is interrupted for the first period of time and the voltage of the battery is less than the predetermined voltage, the second control device may transmit a transmission request for the shutoff request to the first control device via the communication when the communication with the first control device is continuously interrupted for a second period of time longer than the first period of time, and may turn off the relay when the communication with the first control device is interrupted even after a third period of time elapses after the transmission request is transmitted. In this way, the relay can be turned off at a more appropriate timing.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a configuration diagram illustrating an outline of a configuration of a battery electric vehicle including a control device according to an embodiment of the present disclosure; and

FIG. 2 is a flow chart illustrating an exemplary process performed by the battery ECU.

### DETAILED DESCRIPTION OF EMBODIMENTS

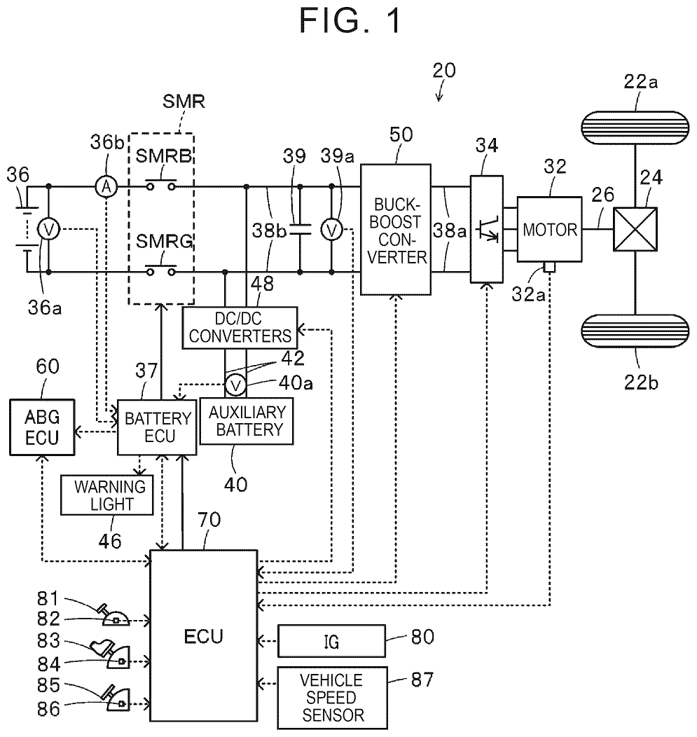

Embodiments of the present disclosure will be described with reference to the drawings. FIG. 1 is a block diagram schematically illustrating a configuration of a battery electric vehicle including a relay control system according to an embodiment of the present disclosure. As illustrated, battery electric vehicle 20 includes a motor 32, an inverter 34, a battery 36, and a battery electronic control unit (hereinafter, referred to as a “battery ECU”) 37, and further, battery electric vehicle 20 includes a system main relay SMR, an auxiliary battery 40, a DC/DC converter 48, a step-up/step-down converter 50, an airbag electronic control unit (hereinafter, referred to as an ABG ECU) 60, and an electronic control unit (hereinafter, referred to as an ECU) 70. ECU 37 of the battery and ECU 70 are mainly used as the relay control system of the present embodiment. Note that, in FIG. 1, solid arrows indicate direct lines as signal wires for exchanging signals on a one-to-one basis. A dashed arrow indicates a communication line (for example, a communication line for CAN communication) as a signal wire capable of exchanging signals with a plurality of apparatuses.

The motor 32 is configured as a synchronous generator motor, and includes a rotor in which a permanent magnet is embedded in a rotor core, and a stator in which a three-phase coil is wound around the stator core. The rotor of the motor 32 is connected to a driving shaft 26 that is coupled to driving wheels 22a, 22b through a differential gear 24.

The inverter 34 is connected to the motor 32 and is connected to the high-voltage-side power line (second power line) 38a, which inverter 34 is configured as a well-known inverter circuitry having six transistors and six LEDs. The motor 32 is rotationally driven by switching control of a plurality of switching elements (not shown) of the inverter 34. The inverters 34 are connected to ECU 70 via communication lines.

The step-up/step-down converter 50 is connected to the high-voltage-side power line 38a and the low-voltage-side power line (first power line) 38b. The step-up/down converter 50 is configured as a well-known step-up/down converter circuit including two transistors and two diodes constituting the upper arm and the lower arm, and a reactor. ECU 70 adjusts the ratio of the on-times of the two transistors constituting the upper and lower arms. Thus, the step-up/step-down converter 50 boosts the power of the low-voltage-side power line 38b and supplies the boosted power to the high-voltage-side power line 38a, or lowers the voltage of the high-voltage-side power line 38a and supplies the boosted power to the low-voltage-side power line 38b. A smoothing capacitor (not shown) is attached to the positive line and the negative line of the high-voltage-side power line 38a. A smoothing capacitor 39 is attached to the positive line and the negative line of the low-voltage-side power line 38b.

The battery 36 is configured as, for example, a lithium ion secondary battery or a nickel hydrogen secondary battery having a rated voltage of about several hundred V. The battery 36 is managed in a battery ECU 37.

Although not shown, the battery ECU 37 is configured as a microprocessor centered on CPU. In addition to CPU, the battery ECU 37 includes a ROM for storing a process program, a RAM for temporarily storing data, a flash memory for storing and holding data, an input/output port, and a communication port. The battery ECU 37 is connected to the system main relay SMR via a direct line. In the battery ECU 37, a voltage (a voltage between terminals of the battery 36) Vb from a voltage sensor 36a attached between terminals of the battery 36, a current Ib from a current sensor 36b attached to an output terminal of the battery 36, and a voltage VL from a voltage sensor 40a for detecting a voltage between terminals of the auxiliary battery 40 are inputted via a communication line and an input port. The battery ECU 37 outputs a lighting signal or the like to a warning light (informing device) 46 installed in the vehicle cabin via an output port or a communication line. The battery ECU 37 outputs a drive signal to the system main relay SMR via an output port and a direct line.

The system main relay SMR is connected to the low-voltage-side power line 38b. The system main relay SMR includes a positive-side relay SMRB provided in the positive line of the low-voltage-side power line 38b, and a negative-side relay SMRG provided in the negative line of the low-voltage-side power line 38b.

The auxiliary battery 40 is configured as, for example, a lithium-ion secondary battery, a nickel-hydrogen secondary battery, or a lead-acid battery having a rated voltage of 10-odd V. The auxiliary battery 40 is connected to an auxiliary-side power line 42 together with an auxiliary machine, a DC/DC converter 48, and a battery ECU 37, ABG ECU 60, ECU 70 (not shown).

DC/DC converters 48 are connected to the low-voltage-side power lines 38b and the auxiliary-side power lines 42. DC/DC converters 48 step down the power of the low-voltage-side power line 38b and supply it to the auxiliary-side power line 42, or step up the power of the auxiliary-side power line 42 and supply it to the low-voltage-side power line 38b. DC/DC converters 48 are connected to ECU 70 via communication lines.

Although not shown, ABG ECU 60 is configured as a microprocessor centered on CPU. In addition to CPU, ABG ECU 60 includes a ROM for storing a process program, a RAM for temporarily storing data, a flash memory for storing and holding data, an input/output port, and a communication port. ABG ECU 60 controls an airbag (not shown) and determines a crash of the vehicle. ABG ECU 60 is connected to ECU 70 via a communication line.

Although not shown, ECU 70 is configured as a microprocessor centered on CPU. In addition to CPU, ECU 70 includes a ROM for storing a process program, a RAM for temporarily storing data, a flash memory for storing and holding data, an input/output port, and a communication port. ECU 70 is connected to the inverter 34, DC/DC converter 48, the step-up/down converter 50, and ABG ECU 60 via a communication line. ECU 70 is connected to the battery ECU 37 via a direct line and a communication line. ECU 70 includes a communication line and an input port through which signals from various sensors are input. For example, the rotational position θm from a rotational position detecting sensor (e.g., a resolver) 32a that detects the rotational position of the rotor of the motor 32 may be used as the signal inputted to ECU 70. In addition, a voltage VL of the capacitor 39 (low-voltage-side power-line 38b) from the voltage sensor 39a attached between the terminals of the capacitor 39 may be cited. Examples of the signal inputted to ECU 70 include an ignition signal from the ignition switch 80, a shift position SP from the shift position sensor 82 that detects the operating position of the shift lever 81, and an accelerator operation amount Acc from the accelerator pedal position sensor 84 that detects the depression amount of the accelerator pedal 83. ECU 70 may include the brake pedal position BP from the brake pedal position sensor 86 that detects the depression amount of the brake pedal 85, and the vehicle speed V from the vehicle speed sensor 87. Various control signals are output from ECU 70 via a communication line and an output port. Examples of the signal outputted from ECU 70 include a control signal to the transistor of the inverter 34, a control signal to DC/DC converter 48, and a control signal to the step-up/step-down converter 50.

In battery electric vehicle 20 configured as described above, the system main relay SMR is turned on and travels with power from the motor 32. When the system main relay SMR is turned on, ECU 70 transmits a request to connect the system main relay SMR to the battery ECU 37 via communication via the communication line and the direct line. The battery ECU 37 receives a request to connect the system main relay SMR via communication by at least one of the communication line and the direct line. The battery ECU 37, which has received the connection request, supplies a drive current to the direct line connected to the system main relay SMR to turn on the system main relay SMR (both the positive-side relay SMRB and the negative-side relay SMRG are turned on).

When ABG ECU 60 determines a collision of the vehicle, ABG ECU 60 transmits a collision determination signal to ECU 70 via the communication line. ECU 70 transmits a request for shutting down the system main relay SMR to the battery ECU 37 via communication using the communication line and the direct line. The battery ECU 37 receives a request to shut down the system main relay SMR. The battery ECU 37 that has received the shut-off request stops supplying the drive current to the direct line connected to the system main relay SMR and turns off the system main relay SMR (turns off at least one of the positive-side relay SMRB and the negative-side relay SMRG).

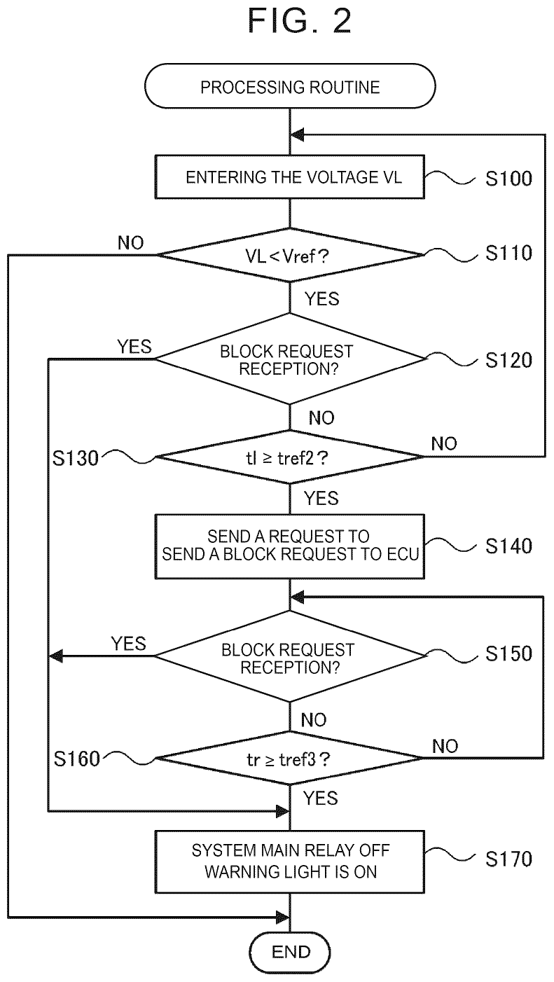

Next, the operation of battery electric vehicle 20 configured in this way, in particular, the operation when a disruption occurs in the communication between the battery ECU 37 and ECU 70 will be described. FIG. 2 is a flow chart illustrating an exemplary process performed by the battery ECU. The communication between the battery ECU 37 and ECU 70 is performed when both the communication by the direct line and the communication by the communication line are interrupted during the first time tref1. The first time tref1 may be, for example, a time period twice or three times the transmission period of a signal in communication using a communication line, and may be, for example, a time period of about several 10 msec to several sec.

When this routine is executed, the battery ECU 37 receives the voltage VL of the auxiliary battery 40 from the voltage sensor 40a (S100). Next, the battery ECU 37 determines whether or not the voltage VL is less than the predetermined voltage Vref (S110). The predetermined voltage Vref is a voltage determined in advance as a lower limit of the power supply voltage when the auxiliary battery 40 is normal. When a problem occurs in the auxiliary battery 40 or the auxiliary-side power line 42 due to a collision of a vehicle or the like, the voltage of the auxiliary battery 40 may be lowered. Therefore, S110 is a process of determining whether or not there is a high possibility of a collision of vehicles occurring. When the voltage VL is equal to or higher than the predetermined voltage Vref, the battery ECU 37 determines that there is a low possibility that a collision has occurred.

When the voltage VL is less than the predetermined voltage Vref in S110, the battery ECU 37 determines whether or not a request to shut off the system main relay SMR has been received from ECU 70 (S120). This routine is executed when the communication between the battery ECU 37 and ECU 70 is interrupted, but the interruption of the communication may be temporary and then resumed. S120 determines whether or not a request to shut down the system main relay SMR has been received from ECU 70 in anticipation of such a return of communication. When the battery ECU 37 receives the shut-off request, it turns off the system main relay SMR and transmits a S170 signal to turn on the warning light 46 to terminate the routine. According to this process, the system main relay SMR can be quickly turned off and the warning light 46 can be turned on to notify the user of the vehicle that the system main relay SMR has been turned off in response to an instruction from ECU 70.

The battery ECU 37 determines whether or not the elapsed time tl after the communication with ECU 70 is interrupted is equal to or more than the second time tref2 when S120 does not receive the shut-off request for the system main relay SMR (S130). The second time tref2 is a predetermined time as a time longer than the first time tref1. When the elapsed-time tl is less than the second time tref2, the process returns to S100 process, and S110 determines that the voltage VL is equal to or higher than the predetermined voltage Vref, or S120 repeats the process of S130 from S100 until it receives a cutoff request from ECU 70. When it is determined in S110 that the voltage VL is equal to or higher than the predetermined voltage Vref, the routine ends as described above. When the shut-off request is received in S120, as described above, the system main relay SMR is turned off and the warning light 46 is turned on (S170), and the routine is ended.

In some cases, the state in which the voltage VL is less than the predetermined voltage Vref is not resolved, and the elapsed time tl becomes equal to or more than the second time tref2 without receiving the shut-off request from ECU 70. In this situation, the battery ECU 37 determines that there is a high possibility that some trouble has occurred in the communication line, the direct line, or the auxiliary battery 40 connected to ECU 70 due to a collision or the like of the vehicle. Then, the battery ECU 37 transmits, to ECU 70, a request to transmit a request to shut down the system main relay SMR (S140). ECU 70 transmits a request for shutting off the system main relay SMR to the battery ECU 37 via communication by the direct line and the communication line when receiving a request for transmitting a request for shutting off the system main relay SMR from the battery ECU 37.

Then, the battery ECU 37 determines whether or not a request to shut off the system main relay SMR from ECU 70 has been received (S150). The interruption of the communication between the battery ECU 37 and ECU 70 due to at least one of the direct line and the communication line may be eliminated. In this case, although the request to shut off the system main relay SMR from ECU 70 can be received, the request to shut off the system main relay SMR from ECU 70 cannot be received when the interruption of the communication by the direct line and the communication line between the battery ECU 37 and ECU 70 is not eliminated. Therefore, S150 is a process of determining whether or not the interruption of the communication by the direct line and the communication line between the battery ECU 37 and ECU 70 has been resolved.

S150 may not receive a system main-relay SMR shutdown request from ECU 70. In this situation, the battery ECU 37 determines that the interruption of the communication by the direct line and the communication line between the battery ECU 37 and ECU 70 has not been eliminated. Then, the battery ECU 37 determines whether or not the elapsed time tr from the time when S140 transmits the request to shut down the system main relay SMR is equal to or greater than the third time tref3 (S160). When the elapsed time tr is less than the third time tref3, the battery ECU 37 repeats S150, S160 until a shut-off request is received from ECU 70 in S150 or the elapsed time tr becomes equal to or more than the third time tref3 in S160. S150 may receive a shutdown request from ECU 70. In this situation, the battery ECU 37 determines that the interruption of the communication between the battery ECU 37 and ECU 70 by the direct line and the communication line has been eliminated, and the interruption demand has been received from ECU 70. Then, the battery ECU 37 immediately turns off the system main relay SMR and transmits a lighting signal so that the warning light 46 is turned on (S170), and ends the routine. According to this process, the system main relay SMR can be quickly turned off and the warning light 46 can be turned on to notify the user of the vehicle that the system main relay SMR has been turned off in response to an instruction from ECU 70.

When the elapsed time tr is equal to or longer than the third time tref3 in S160, the battery ECU 37 turns off the system main relay SMR and transmits a lighting signal so that the warning light 46 is turned on (S170), and ends the routine. With such a process, the battery ECU 37 can turn off the system main relay SMR even when communication with ECU 70 is not interrupted. Further, the battery ECU 37 may turn on the warning light 46 to notify the user of the vehicle that the system main relay SMR has been turned off.

According to the relay control system of the present embodiment described above, the battery ECU 37 can turn off the system main relay SMR at a more appropriate timing by turning off the system main relay SMR when the voltage VL of the auxiliary battery 40 is less than the predetermined voltage Vref when the communication of ECU 70 is tref1 interrupted for the first time.

When the communication with ECU 70 is interrupted for the first time tref1 and the voltage VL of the auxiliary battery 40 is less than the predetermined voltage Vref, the battery ECU 37 turns off the system main relay SMR when the time when the communication with ECU 70 is interrupted continues for the second time tref2 longer than the first time tref1. Accordingly, the battery ECU 37 can turn off the system main relay SMR at a more appropriate timing.

Further, the relay control system of the present embodiment may further include a warning light 46. Then, when the communication with ECU 70 is interrupted for the first time tref1 and the voltage VL of the auxiliary battery 40 is less than the predetermined voltage Vref, and the time when the communication with ECU 70 is interrupted continues for the second time tref2 longer than the first time tref1, the battery ECU 37 turns on the warning light 46 so as to be notified that the relay is turned off. Accordingly, the convenience of the user can be improved.

When ECU 70 communication is interrupted tref1 the first time, when the voltage VL of the auxiliary battery 40 is less than the predetermined voltage Vref, the transmission request of the interruption request is transmitted to ECU 70 via the communication, and when the communication with ECU 70 is interrupted even after the third time tref3 elapses after the transmission request, the battery ECU 37 turns off the system main relay SMR. Thus, the system main relay SMR can be turned off at a more appropriate timing.

Further, when the communication with ECU 70 is interrupted for the first time tref1 and the voltage VL of the auxiliary battery 40 is less than the predetermined voltage Vref, the battery ECU 37 turns off the system main relay SMR when the time when the communication with ECU 70 is interrupted continues for a second time tref2 longer than the first time tref1, the transmission request of the interruption request is transmitted to ECU 70 via the communication, and the communication with ECU 70 is interrupted even after the third time tref3 elapses after the transmission request is transmitted. Thus, the system main relay SMR can be turned off at a more appropriate timing.

In the above-described embodiment, communication with ECU 70 is interrupted tref1 the first period, and the process routine is executed, and when the voltage VL of the auxiliary battery 40 is less than the predetermined voltage Vref in S110, S170 is executed from S120. However, when the voltage VL of the auxiliary battery 40 is less than the predetermined voltage Vref, S170 may be executed without executing S160 from S120.

In the above-described embodiment, communication with ECU 70 is interrupted tref1 the first period, and the process routine is executed. In addition, when the voltage VL of the auxiliary battery 40 is less than the predetermined voltage Vref in S110, and the elapsed time tl after the communication with ECU 70 is interrupted is equal to or more than the second time tref2, S170 is executed from S140. However, S170 may be executed without executing S160 from S140.

In the above-described embodiment, battery electric vehicle 20 includes a warning light 46, and the warning light 46 is turned on when the system main relay SMR is turned off in S170. However, battery electric vehicle 20 may be provided with a display for displaying information together with the warning light 46 or a speaker for outputting information by sound instead of the warning light 46. When the system main relay SMR is turned off in S170, instead of turning on the warning light 46 or turning on the warning light 46, a message indicating that the system main relay SMR is turned off may be displayed on the display, or a message indicating that the system main relay SMR is turned off may be outputted from the speaker. In addition, in S170, only the process of turning off the system main relay SMR may be executed without turning on the warning light 46.

In the above-described embodiment, when the communication with ECU 70 is interrupted for the first time tref1 and the process routine is executed, and when the voltage VL of the auxiliary battery 40 is less than the predetermined voltage Vref, the elapsed time tl from the interruption of the communication with ECU 70 is equal to or more than the second time tref2, the battery ECU 37 transmits a request to transmit the interruption request. However, when the communication with ECU 70 is interrupted by the first time tref1 and the process routine is executed, and the voltage VL of the auxiliary battery 40 is less than the predetermined voltage Vref, the battery ECU 37 may transmit the shut-off request without determining whether the elapsed time tl is equal to or greater than the second time tref2 (without executing S130).

In the above-described embodiment, the control target in the relay control system of the present disclosure is a system main relay SMR. However, instead of the system main relay SMR, the present disclosure may be applied to a relay attached to another wire.

The correspondence between the main elements of the embodiments and the main elements of the disclosure described in the column of the means for solving the problem will be described. In the embodiment, ECU 70 corresponds to the “first control device” and the battery ECU 37 corresponds to the “second control device”.

Note that the correspondence between the main elements of the embodiment and the main elements of the disclosure described in the section of the means for solving the problem is an example for specifically explaining the embodiment of the disclosure described in the section of the means for solving the problem, and therefore the elements of the disclosure described in the section of the means for solving the problem are not limited. That is, the interpretation of the disclosure described in the section of the means for solving the problem should be performed based on the description in the section, and the embodiments are only specific examples of the disclosure described in the section of the means for solving the problem.

Hereinafter, while embodiments for carrying out the present disclosure are described by using embodiments, it is needless to say that the present disclosure is not limited to such embodiments, and can be implemented in various forms without departing from the gist of the present disclosure.

The present disclosure is applicable to a manufacturing industry of a relay control system and the like.

What is claimed is:

1. A relay control system comprising a first control device that is operated by power from a battery and that transmits a shutoff request for a relay, and a second control device that turns off the relay when the shutoff request from the first control device is received via communication, wherein when the communication with the first control device is interrupted for a first period of time, the second control device turns off the relay when a voltage of the battery is less than a predetermined voltage.

2. The relay control system according to claim 1, wherein when the communication with the first control device is interrupted for the first period of time and the voltage of the battery is less than the predetermined voltage, the second control device turns off the relay when the communication with the first control device is continuously interrupted for a second period of time longer than the first period of time.

3. The relay control system according to claim 2, further comprising an informing device that indicates information, wherein when the communication with the first control device is interrupted for the first period of time and the voltage of the battery is less than the predetermined voltage, the second control device controls the informing device so as to indicate that the relay is turned off when the communication with the first control device is continuously interrupted for the second period of time.

4. The relay control system according to claim 1, wherein when the communication with the first control device is interrupted for the first period of time, the second control device transmits a transmission request for the shutoff request to the first control device via the communication when the voltage of the battery is less than the predetermined voltage, and turns off the relay when the communication with the first control device is interrupted even after a third period of time elapses after the transmission request is transmitted.

5. The relay control system according to claim 1, wherein when the communication with the first control device is interrupted for the first period of time and the voltage of the battery is less than the predetermined voltage, the second control device transmits a transmission request for the shutoff request to the first control device via the communication when the communication with the first control device is continuously interrupted for a second period of time longer than the first period of time, and turns off the relay when the communication with the first control device is interrupted even after a third period of time elapses after the transmission request is transmitted.
